(19) United States
(12) Patent Application Publication
(10) Pub. No.: US 2026/0227026 A1
(43) Pub. Date: Aug. 6, 2026

(54) BRACKET WITH ADJUSTABLE ANGLES

(71) Applicant: Dongguan Qingyi Hardware Technology Co., Ltd., Dongguan (CN)

(72) Inventor: Bo Feng, Dazhou (CN)

(21) Appl. No.: 19/635,664

(22) Filed: Mar. 31, 2026

(30) Foreign Application Priority Data
Mar. 23, 2026 (CN) 202620363385.6

(51) Int. Cl. F16M 11/20; F16M 11/10

(52) U.S. Cl. CPC F16M 11/2021; F16M 11/105; F16M 2200/044

(57) ABSTRACT

Provided is a bracket with adjustable angles, which includes an installation base, an installation frame, a connection shaft, and a torsion spring. The installation frame is rotatably connected to the installation base through the connection shaft, and the torsion spring is sleeved on an outer side of the connection shaft. The torsion spring has a first torsion arm and a second torsion arm, and the first torsion arm is in contact with the installation frame. The installation base is provided with a torsion spring adjustment component. The torsion spring adjustment component includes a worm wheel and a worm shaft that controls a rotation of the worm wheel. The worm shaft is rotatably provided on the installation base, and the worm wheel is rotatably provided on the connection shaft. The worm wheel and the connection shaft are coaxially arranged.

### CROSS-REFERENCE TO RELATED APPLICATIONS

This application claims priority to Chinese Patent Application No. 202620363385.6, filed on March 23, 2026, which is hereby incorporated by reference in its entirety.

### TECHNICAL FIELD

The present disclosure relates to the field of bracket technologies, and in particular, to a bracket with adjustable angles.

### BACKGROUND

Brackets are fixed support components widely used in products such as displays, mobile phones, fans, and tables and chairs. It can be divided into fixed brackets and movable brackets according to its structural form.

Where the movable bracket mainly consists of an installation base, an installation frame, a connection shaft, and a torsion spring: the installation frame is rotatably connected to the installation base through the connection shaft, and the torsion spring is sleeved on the outside of the connection shaft. The installation frame is used to install mobile terminals.

To meet the adjustment needs of different usage scenarios, the movable bracket is usually provided with a torsion spring adjustment device to adjust a torque of the torsion spring, thereby adjusting an angle between the installation base and the installation frame. However, existing torsion spring adjustment devices generally have problems such as complex structure, difficult adjustment, and inconvenient operation, which affect the user’s experience and adjustment efficiency.

The present disclosure provides a bracket with adjustable angles to address the shortcomings of existing technology, which simplifies the structure of the torsion spring adjustment device, makes the torsion spring easy to adjust, and improves the adjustment efficiency.

To achieve the above objectives, the present disclosure adopts the following technical solution.

A bracket with adjustable angles, including: an installation base, an installation frame, a connection shaft, and a torsion spring; the connection shaft is rotatably provided on the installation frame, and the installation frame is rotatably connected to the installation base through the connection shaft; the torsion spring is sleeved on an outside of the connection shaft, and the torsion spring has a first torsion arm and a second torsion arm; the first torsion arm abuts against the installation frame and further includes a torsion spring adjustment component; where the torsion spring adjustment component includes a worm wheel and a worm shaft that controls a rotation of the worm wheel; the worm shaft is rotatably provided on the installation base, and the worm wheel is rotatably provided on the connection shaft; the worm wheel and the connection shaft are coaxially arranged; the second torsion arm is connected to the worm wheel and is configured to be driven to move by the worm wheel. By providing the worm wheel and worm shaft, the worm shaft drives the worm gear to rotate, and the worm wheel drives the second torsion arm to move, thereby achieving an adjustment of a torque of the torsion spring. Due to the self-locking characteristics of the worm wheel and worm shaft, there is no need to provide a locking component, thus simplifying the structure of the torsion spring adjustment component and facilitating adjustment, solving the problems of low adjustment efficiency and inconvenient adjustment.

In some embodiments of the present disclosure, the worm wheel is provided with a first installation groove, and the second torsion arm is embedded in the first installation groove.

In some embodiments of the present disclosure, the torsion spring includes a first coil and a second coil that are coaxially arranged, the first coil and the second coil are connected through the second torsion arm, and the worm wheel is provided between the first coil and the second coil.

In some embodiments of the present disclosure, a support seat is provided on the installation frame, and a connection slot is provided on the support seat, and the first torsion arm is in contact with the connection slot.

In some embodiments of the present disclosure, the connection slot is provided with a notch, and the first torsion arm enters or exits the connection slot along the notch.

In some embodiments of the present disclosure, the support seat has two support arms, and the two support arms are spaced apart, each of the two support arms is provided with a first installation hole; two ends of the connection shaft are respectively threaded into the corresponding first installation holes.

In some embodiments of the present disclosure, the connection shaft includes a screw, a rotating sleeve, and a locking bolt, the rotating sleeve is sleeved on an outside of the screw, the worm wheel is fixedly provided on an outside of the rotating sleeve, the screw passes through two of the first installation holes, the rotating sleeve is sleeved on the screw and provided between the two support arms, a free end of the screw is provided with an axially extending threaded hole, and the locking bolt is threadedly connected to the threaded hole.

In some embodiments of the present disclosure, each of the first installation holes is provided with shaft sleeves, and the screw is threaded into two of the shaft sleeves; two ends of the rotating sleeve are respectively rotatably sleeved on an outer side of one corresponding shaft sleeve, and an outer wall of a peripheral side of each of the shaft sleeves is in contact with an inner wall of a peripheral side of the rotating sleeve; one end of each of the shaft sleeves away from the rotating sleeve is provided with an installation plate, and positioning blocks are provided on the installation plate; positioning holes corresponding to the positioning blocks are provided on the two support arms, and the positioning blocks are embedded in the positioning holes to limit a relative rotation of each of the shaft sleeves to the corresponding support arm.

In some embodiments of the present disclosure, the installation base is provided with a second installation hole and a third installation hole, a shape of the second installation hole is adapted to a head of the screw, the head of the screw is fixedly embedded in the second installation hole, and a free end of the screw is inserted into the third installation hole.

In some embodiments of the present disclosure, a washer spring is provided between the locking bolt and the installation base, and the screw is threaded in the washer spring; one end of the washer spring abuts against the installation base, and the other end thereof abuts against a head of the locking bolt.

In some embodiments of the present disclosure, a limit sleeve is provided in the second installation hole, the limit sleeve is sleeved on an outside of the screw, a limit groove is provided on one side of the limit sleeve away from the rotating sleeve, and the head of the screw is embedded in the limit groove.

In some embodiments of the present disclosure, two ends of the worm shaft are respectively provided with a first installation shaft and a second installation shaft, the first installation shaft, the second installation shaft, and the worm shaft are coaxially arranged, the installation base is provided with a first shaft hole and a second shaft hole, the first installation shaft is rotatably arranged in the first shaft hole, and the second installation shaft is rotatably arranged in the second shaft hole.

In some embodiments of the present disclosure, a second installation groove is provided on the installation base, and the worm shaft is provided in the second installation groove; one side of the second installation groove is communicated to the second shaft hole, and the other side of the second installation groove is communicated to the third installation groove; one side of the second installation groove away from the second shaft hole is open, and a positioning plate is provided in the second installation groove, the first shaft hole is provided on the positioning plate.

In some embodiments of the present disclosure, the positioning plate has a positioning portion and two connection portions, the positioning portion is provided between the two connection portions, the first shaft hole is provided on the positioning portion, the third installation groove has a first concave portion corresponding to the positioning portion and two second concave portions corresponding to the two connection portions one by one, the positioning portion is partially embedded in the first concave portion, each of the two connection portions is provided with a first connection hole, each of the second concave portions is provided with a second connection hole, and the two connection portions are embedded in the corresponding second concave portions, the screw passing through the first connection hole and the second connection hole in sequence so as to connect the positioning plate and the installation base.

In some embodiments of the present disclosure, end faces of the first installation shaft and/or the second installation shaft are provided with adjustment holes, and the installation base is provided with a through hole for exposing the adjustment holes.

Compared with the existing technology, the present disclosure has obvious advantages and beneficial effects.

1. By coordinating the worm wheel and worm shaft, the worm shaft drives the worm wheel to rotate, and the worm wheel drives the second torsion arm to move, thereby achieving an adjustment of the torque of the torsion spring. Due to the self-locking characteristics of the worm wheel and worm shaft, there is no need to arrange a locking component, thus simplifying the structure of the torsion spring adjustment component, facilitating adjustment, and improving adjustment efficiency.

2. The combination of worm wheel and worm shaft can achieve a 270 ° rotation of the installation base relative to the installation frame, with a large adjustment angle, improving the user experience.

To provide a clearer explanation of the structural features, technical means, and specific objectives and functions achieved by the present disclosure, the following will provide further detailed explanations of the present disclosure in combination with the accompanying drawings and specific embodiments.

### BRIEF DESCRIPTION OF DRAWINGS

FIG. 1 is a schematic diagram of an assembly structure of an embodiment of the present disclosure.

FIG. 2 is a first angle sectional view of an embodiment of the present disclosure.

FIG. 3 is a second angle sectional view of an embodiment of the present disclosure.

FIG. 4 is an enlarged schematic structural diagram of point A in FIG. 3.

FIG. 5 is an enlarged schematic structural diagram of point B in FIG. 3.

FIG. 6 is a preliminary exploded structural diagram of an embodiment of the present disclosure.

FIG. 7 is a schematic diagram of a further decomposed structure in a first view of an embodiment of the present disclosure.

FIG. 8 is a schematic diagram of a further decomposed structure of an embodiment of the present disclosure in a second view.

Numeral reference: 10- installation base; 101- first shaft hole; 102- second shaft hole; 11- worm shaft; 111- first installation shaft; 112- second installation shaft; 113- adjustment hole; 12- second installation hole; 13- third installation hole; 14- limit sleeve; 15- limit groove; 16- second installation groove; 17- third installation groove; 171- first concave portion; 172- second concave portion; 173- second connection hole; 18- positioning plate; 181- positioning portion; 182- connection portion; 183- first connection hole; 19-hole cover; 20- installation frame; 21- support seat; 22- connection slot; 221- notch; 23- support arm; 231- positioning hole; 24- first installation hole; 30- connection shaft; 31- worm wheel; 311- first installation groove; 32- screw; 321- threaded hole; 33- rotating sleeve; 34- locking bolt; 35- shaft sleeve; 36-installation plate; 361- positioning block; 37- washer spring; 38- abutting piece; 40- torsion spring; 41- first torsion arm; 42- second torsion arm; 43- first coil; 44- second coil.

### DESCRIPTION OF EMBODIMENTS

In the description of the present disclosure, it should be noted that terms “center”, “up”, “down”, “left”, “right”, “vertical”, “horizontal”, “inside”, “outside” and other directional or positional relationships indicated are based on the directional or positional relationships shown in the accompanying drawings, only for the convenience of describing the present disclosure and simplifying the description, and do not indicate or imply that the positions or elements referred to must have specific orientations, be constructed and operated in specific orientations, and therefore cannot be understood as limitations on the present disclosure.

In the description of the present disclosure, it should be noted that unless otherwise specified and limited, terms “installation”, “connection to”, and “connection with” should be broadly understood, for example, it can be a fixed connection, a detachable connection, or an integrated connection; it can be a mechanical connection or an electrical connection; it can be directly connected, indirectly connected through an intermediate medium, or connected internally between two components. For those skilled in the art, specific meanings of the above terms in the present disclosure can be understood according to the specific situation.

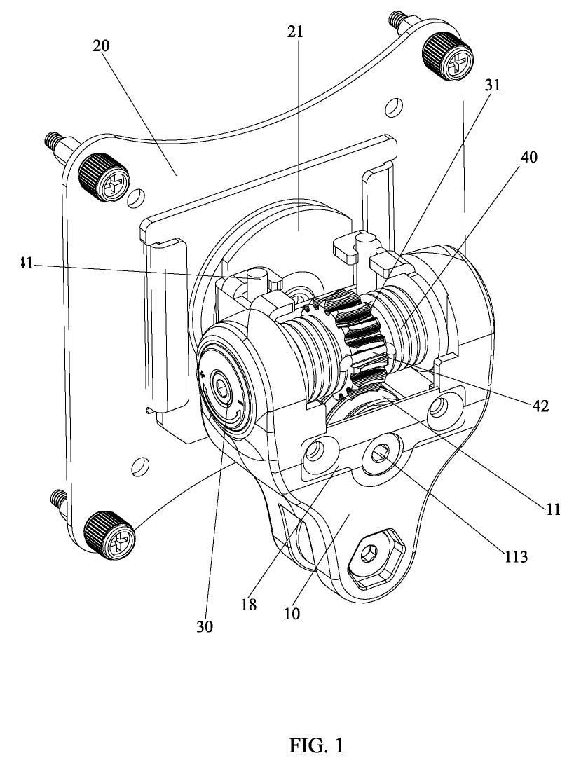

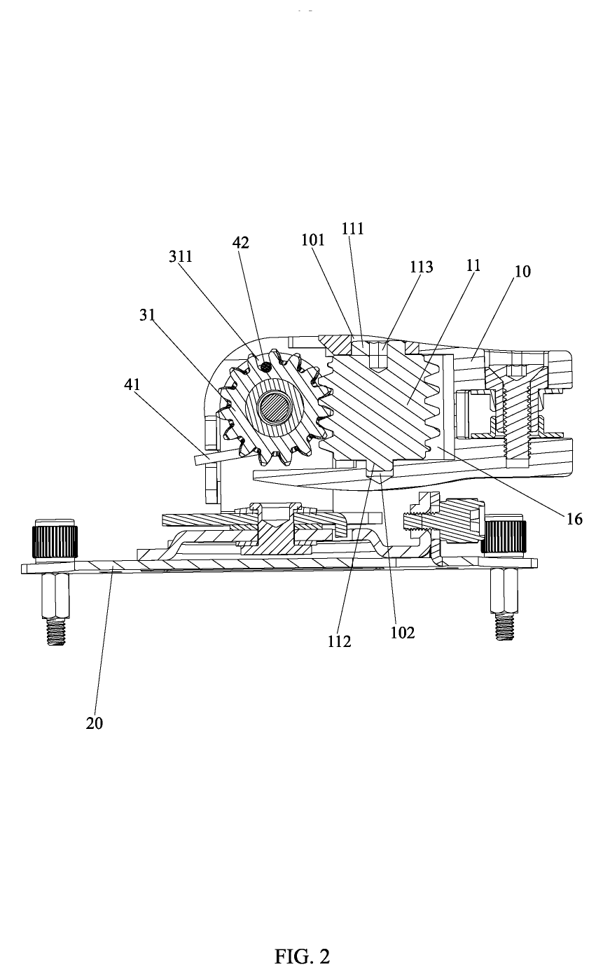

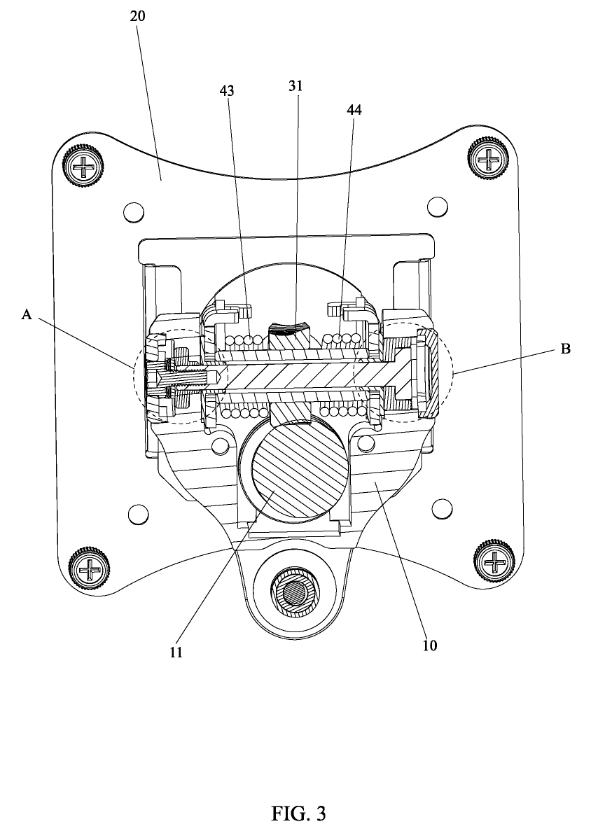

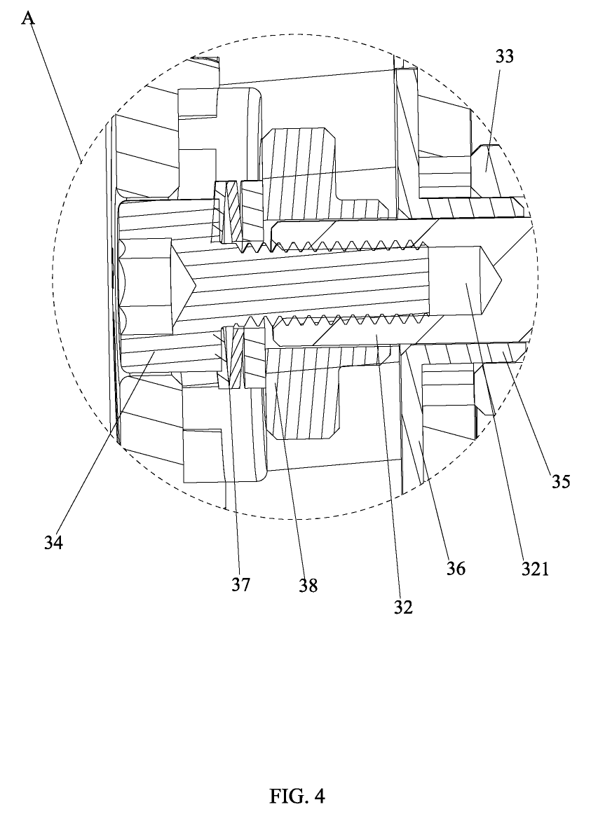

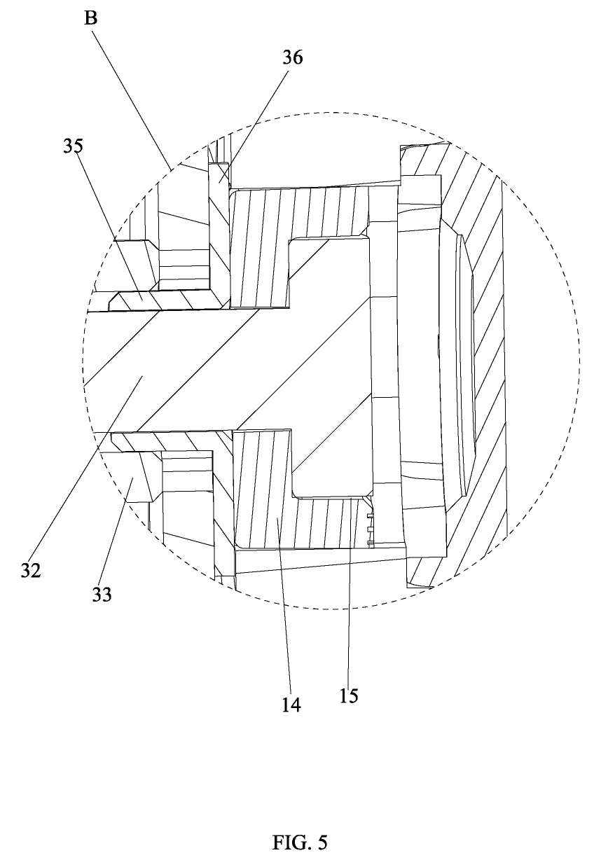

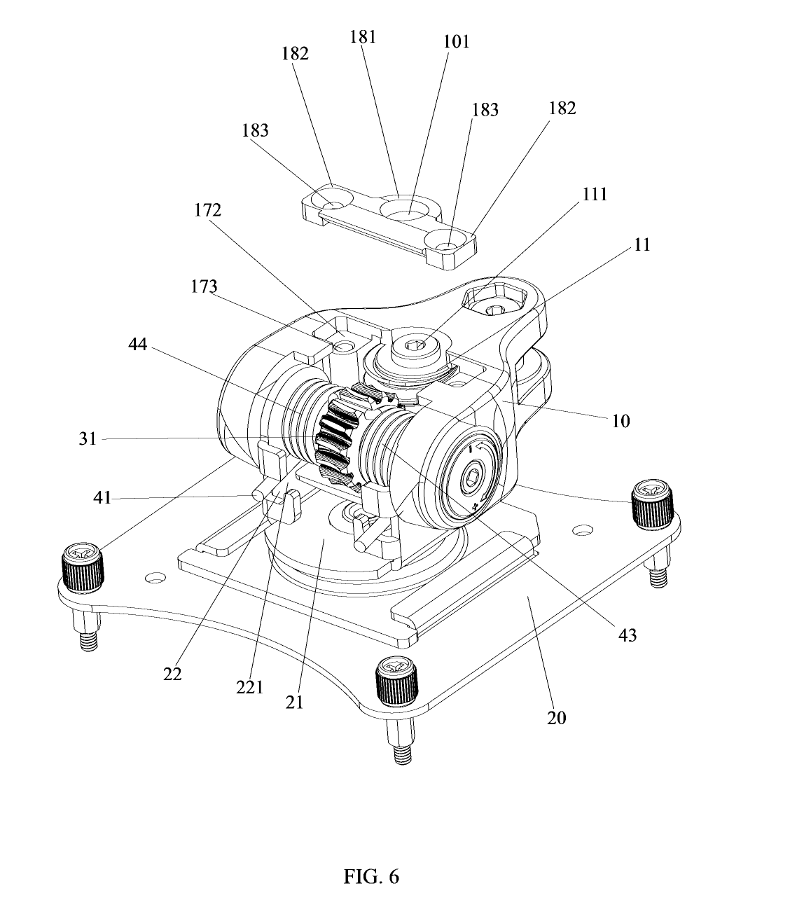

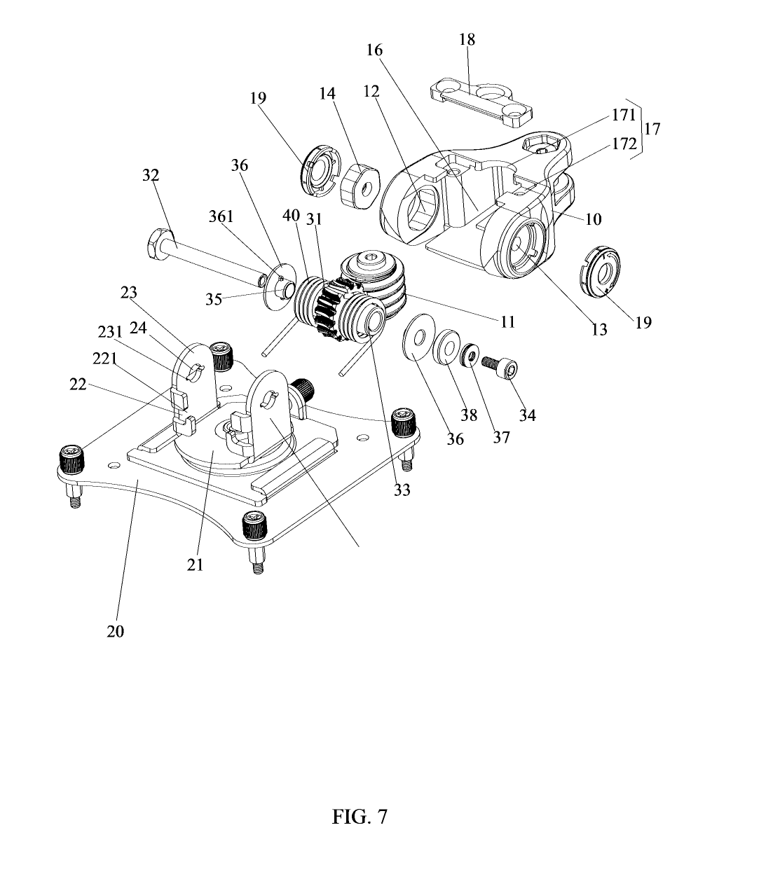

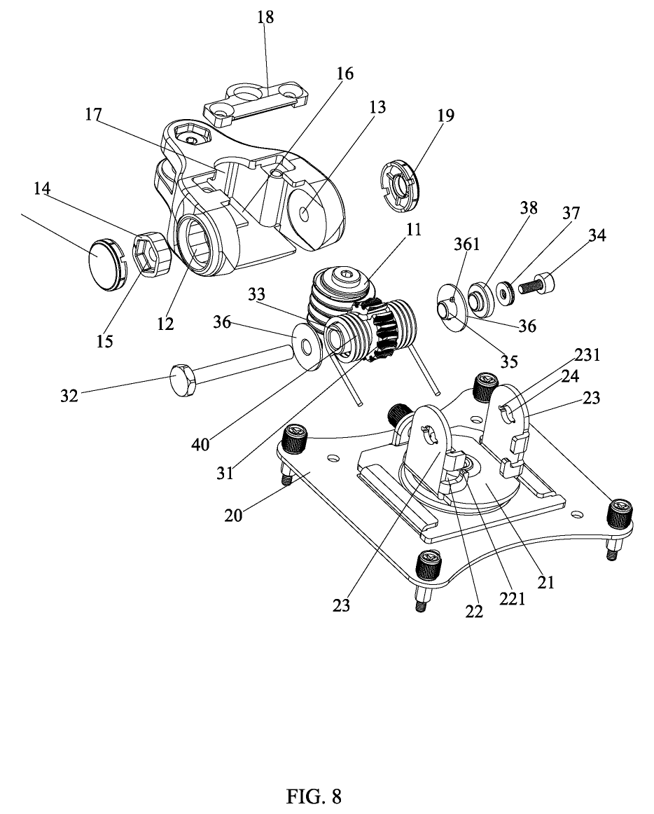

As shown in FIGS. 1-8, the present disclosure discloses a bracket with adjustable angles, including an installation base 10, an installation frame 20, a connection shaft 30, and a torsion spring 40. The connection shaft 30 is rotatably provided on the installation frame 20, and the installation frame 20 is rotatably connected to the installation base 10 through the connection shaft 30. The torsion spring 40 is sleeved on an outside of the connection shaft 30, and has a first torsion arm 41 and a second torsion arm 42. The first torsion arm 41 is in contact with the installation frame 20 and includes a torsion spring adjustment component. The torsion spring adjustment component includes a worm wheel 31 and a worm shaft 11 that controls a rotation of the worm wheel 31. The worm shaft 11 is rotatably provided on the installation base 10, and the worm wheel 31 is rotatably provided on the connection shaft 30. The worm wheel 31 and the connection shaft 30 are coaxially arranged, and the second torsion arm 42 is connected to the worm wheel 31 and can be driven to move by the worm wheel 31. The worm wheel 31 is provided with a first installation groove 311, and the second torsion arm 42 is embedded in the first installation groove 311. The torsion spring 40 includes a first coil 43 and a second coil 44 that are arranged coaxially, the first coil 43 and the second coil 44are connected through the second torsion arm 42. The worm wheel 31 is arranged between the first coil 43 and the second coil 44. By coordinating the worm wheel 31 and worm shaft 11, the worm shaft 11 drives the worm wheel 31 to rotate, and the worm wheel 31 drives the second torsion arm 42 to move, thereby achieving an adjustment of a torque of the torsion spring 40. Due to self-locking characteristics of the worm wheel 31 and the worm shaft 11, there is no need to arrange a locking component, thus simplifying the structure of the torsion spring adjustment component and facilitating adjustment, solving the problems of low adjustment efficiency and inconvenient adjustment.

The installation frame 20 is provided with a support seat 21, and the support seat 21 is provided with a connection slot 22. The first torsion arm 41 is in contact with the connection slot 22. The connection slot 22 is provided with a notch 221, and the first torsion arm 41 enters or exits the connection slot 22 along the notch 221. By providing the notch 221, it is easy to install the first torsion arm 41 into the connection slot 22, which facilitates an installation of the torsion spring 40.

The support seat 21 has two support arms 23, and the two support arms 23 are spaced apart. Each of the support arms 23 is provided with a first installation hole 24, and two ends of the connection shaft 30 are respectively threaded into the corresponding first installation hole 24. The connection shaft 30 includes a screw 32, a rotating sleeve 33, and a locking bolt 34. The rotating sleeve 33 is sleeved on an outside of the screw 32, and the worm wheel 31 is fixedly provided on an outside of the rotating sleeve 33. The screw 32 is threaded through two of the first installation holes 24, and the rotating sleeve 33 is sleeved on the screw 32 and provided between two support arms 23. A free end of the screw 32 is provided with an axially extending threaded hole 321, and the locking bolt 34 is threadedly connected to the threaded hole 321. By providing two support arms 23 to provide double pivot support for the connection shaft 30, the rigidity and stability of the structure are enhanced. The connection shaft 30 adopts a separate design of screw 32 and rotating sleeve 33, which facilitates separate processing and assembly.

Each of the first installation holes 24 is provided with shaft sleeves 35, and the screw 32 is threaded through two of the shaft sleeves 35. Two ends of the rotating sleeve 33 are respectively rotatably sleeved on an outer side of the corresponding shaft sleeve 35, and an outer wall of a peripheral side of each of the shaft sleeves 35 is in contact with an inner wall of a peripheral side of the rotating sleeve 33. An installation plate 36 is provided at one end of the shaft sleeves 35 away from the rotating sleeve 33, and positioning blocks 361 are provided on the installation plate 36. The two support arms 23 are both provided with positioning holes 231 corresponding to the positioning blocks 361. The positioning blocks 361 are embedded in the positioning holes 231 to limit a relative rotation of each of the shaft sleeves 35 to the corresponding support arm 23. By providing the shaft sleeves 35, the rotating sleeve 33 can maintain stable rotation, reduce vibration and eccentricity. The positioning holes 231 and the positioning blocks 361 can achieve quick installation during installation and also prevent the shaft sleeves 35 from shifting during axial locking.

In the present disclosure, the positioning blocks 361 extend to an outer wall of a peripheral of each of the shaft sleeves 35, and the positioning holes 231 are communicated to an adjacent first installation hole 24. The above design facilitates quick installation and facilitates parts production.

The installation base 10 is provided with a second installation hole 12 and a third installation hole 13. A shape of the second installation hole 12 is adapted to a head of the screw 32, and the head of the screw 32 is fixedly embedded in the second installation hole 12. A free end of the screw 32 is inserted into the third installation hole 13. Through the above design, the connection shaft 30 can stably connect the installation base 10 and the installation frame 20.

In the present disclosure, both the second installation hole 12 and the third installation hole 13 are provided with hole covers 19, which can improve the aesthetic appearance by providing the hole covers 19.

A washer spring 37 is provided between the locking bolt 34 and the installation base 10, and the screw 32 is inserted into the washer spring 37. One end of the washer spring 37 is in contact with the installation base 10, and the other end thereof is in contact with a head of the locking bolt 34. By providing the washer spring 37, compression of the washer spring 37 can provide an avoidance space for bolt rotation, rendering it easier for the bolt to rotate.

In the present disclosure, the installation base 10 is provided with an abutting piece 38, and a free end of the screw 32 is threaded through the abutting piece 38. By providing the abutting piece 38, the wear of the gasket spring 37 on the installation base 10 can be reduced.

The second installation hole 12 is provided with a limit sleeve 14, and the limit sleeve 14 is sleeved on an outer side of the screw 32. The limit sleeve 14 is provided with a limit groove 15 on one side away from the rotating sleeve 33, and the head of the screw 32 is embedded in the limit groove 15. By providing the limit sleeve 14, it is possible to avoid the limit groove 15 being directly provided on the installation base 10. If the limit groove 15 is damaged due to long-term use, the limit sleeve 14 can be replaced directly without replacing the installation base 10, thereby reducing the cost of use.

Two ends of the worm shaft 11 are respectively provided with a first installation shaft 111 and a second installation shaft 112. The first installation shaft 111, the second installation shaft 112, and the worm shaft 11 are coaxially arranged. The installation base 10 is provided with a first shaft hole 101 and a second shaft hole 102. The first installation shaft 111 is rotatably arranged in the first shaft hole 101, and the second installation shaft 112 is rotatably arranged in the second shaft hole 102.

The installation base 10 is provided with a second installation groove 16, and the worm shaft 11 is provided in the second installation groove 16. One side of the second installation groove 16 is communicated to the second shaft hole 102, and the other side of the second installation groove 16 is communicated to the third installation groove 17. One side of the second installation groove 16 away from the second shaft hole 102 is open. A positioning plate 18 is provided in the second installation groove 16, and the first shaft hole 101 is provided on the positioning plate 18. By providing the positioning plate 18, it is easy to install the worm shaft 11 in the second installation groove 16 for assembly.

The positioning plate 18 has a positioning portion 181 and two connection portions 182. The positioning portion 181 is provided between the two connection portions 182, and the first shaft hole 101 is provided on the positioning portion 181. The third installation groove 17 has a first concave portion 171 corresponding to the positioning portion 181 and two second concave portions 172 corresponding to the two connection portions 182 one by one. The positioning portion 181 is partially embedded in the first concave portion 171, and each of the connection portions 182 is provided with a first connection hole 183. Each of the second concave portions 172 is provided with a second connection hole 173, and the two connection portions 182 are embedded in the corresponding second concave portions 172, screw passing through the first connection hole 183 and the second connection hole 173 in sequence to connect the positioning plate 18 and the installation base 10. Through the above design, it is easy to quickly install the positioning plate 18.

In the present disclosure, an end face of the first installation shaft 111 is provided with an adjustment hole 113, and the first shaft hole 101 penetrates the positioning plate 18. During adjustment, an external tool is inserted into the adjustment hole 113 through the first shaft hole 101 to drive the worm shaft 11 to rotate, thereby driving the worm wheel 31 to rotate.

It should be understood that the adjustment hole 113 can also be provided on an end face of the second installation shaft 112, and the second shaft hole 102 can also be adaptively designed to pass through the installation base 10 and connect to the outside, or adjustment holes 113 can be provided on both the first installation shaft 111 and the second installation shaft 112.

The present disclosure achieves the adjustment of the torque of the torsion spring 40 by coordinating the worm wheel 31 and the worm shaft 11, using the worm shaft 11 to drive the worm wheel 31 to rotate, and the worm wheel 31 to drive the second torsion arm 42 to move. Due to the self-locking characteristics of the worm wheel 31 and the worm shaft 11, there is no need to provide a locking component, thus simplifying the structure of the torsion spring adjustment component, facilitating adjustment, and improving adjustment efficiency. The cooperation between the worm wheel 31 and the worm shaft 11 can achieve a 270 ° rotation of the installation base 10 relative to the installation frame 20, with a large adjustment angle, improving the user experience.

The above description is only the preferred embodiment of the present disclosure and is not intended to limit the present disclosure. Therefore, any modifications, equivalent substitutions, improvements, etc. made to the above embodiments based on the actual technology of the present disclosure still fall within the scope of the technical solution of the present disclosure.

What is claimed is:

1. A bracket with adjustable angles, comprising: an installation base, an installation frame, a connection shaft, and a torsion spring;
the connection shaft is rotatably provided on the installation frame, and the installation frame is rotatably connected to the installation base through the connection shaft; the torsion spring is sleeved on an outside of the connection shaft, and the torsion spring has a first torsion arm and a second torsion arm; the first torsion arm abuts against the installation frame and further includes a torsion spring adjustment component;
wherein the torsion spring adjustment component comprises a worm wheel and a worm shaft that controls a rotation of the worm wheel; the worm shaft is rotatably provided on the installation base, and the worm wheel is rotatably provided on the connection shaft; the worm wheel and the connection shaft are coaxially arranged; the second torsion arm is connected to the worm wheel and is configured to be driven to move by the worm wheel.

2. The bracket with adjustable angles according to claim 1, wherein the worm wheel is provided with a first installation groove, and the second torsion arm is embedded in the first installation groove.

3. The bracket with adjustable angles according to claim 1, wherein the torsion spring comprises a first coil and a second coil that are coaxially arranged,
the first coil and the second coil are connected through the second torsion arm, and the worm wheel is provided between the first coil and the second coil.

4. The bracket with adjustable angles according to claim 1, wherein a support seat is provided on the installation frame, a connection slot is provided on the support seat, and the first torsion arm is in contact with the connection slot.

5. The bracket with adjustable angles according to claim 4, wherein the connection slot is provided with a notch, and the first torsion arm enters or exits the connection slot along the notch.

6. The bracket with adjustable angles according to claim 4, wherein the support seat has two support arms, and the two support arms are spaced apart, each of the two support arms is provided with a first installation hole;
two ends of the connection shaft are respectively threaded into the corresponding first installation holes.

7. The bracket with adjustable angles according to claim 6, wherein the connection shaft comprises a screw, a rotating sleeve, and a locking bolt, the rotating sleeve is sleeved on an outside of the screw, the worm wheel is fixedly provided on an outside of the rotating sleeve, the screw passes through two of the first installation holes, the rotating sleeve is sleeved on the screw and provided between the two support arms,
a free end of the screw is provided with an axially extending threaded hole, and the locking bolt is threadedly connected to the threaded hole.

8. The bracket with adjustable angles according to claim 7, wherein each of the first installation holes is provided with shaft sleeves, and the screw is threaded into two of the shaft sleeves;
two ends of the rotating sleeve are respectively rotatably sleeved on an outer side of one corresponding shaft sleeve, and an outer wall of a peripheral side of each of the shaft sleeves is in contact with an inner wall of a peripheral side of the rotating sleeve;
one end of each of the shaft sleeves away from the rotating sleeve is provided with an installation plate, and positioning blocks are provided on the installation plate;
positioning holes corresponding to the positioning blocks are provided on the two support arms, and the positioning blocks are embedded in the positioning holes to limit a relative rotation of each of the shaft sleeves to the corresponding support arm.

9. The bracket with adjustable angles according to claim 7, wherein the installation base is provided with a second installation hole and a third installation hole, a shape of the second installation hole is adapted to a head of the screw,
the head of the screw is fixedly embedded in the second installation hole, and a free end of the screw is inserted into the third installation hole.

10. The bracket with adjustable angles according to claim 9, wherein a washer spring is provided between the locking bolt and the installation base, and the screw is threaded in the washer spring;
one end of the washer spring abuts against the installation base, and the other end thereof abuts against a head of the locking bolt.

11. The bracket with adjustable angles according to claim 10, wherein a limit sleeve is provided in the second installation hole, the limit sleeve is sleeved on an outside of the screw, a limit groove is provided on one side of the limit sleeve away from the rotating sleeve, and the head of the screw is embedded in the limit groove.

12. The bracket with adjustable angles according to claim 1, wherein two ends of the worm shaft are respectively provided with a first installation shaft and a second installation shaft,
the first installation shaft, the second installation shaft, and the worm shaft are coaxially arranged,
the installation base is provided with a first shaft hole and a second shaft hole,
the first installation shaft is rotatably arranged in the first shaft hole, and the second installation shaft is rotatably arranged in the second shaft hole.

13. The bracket with adjustable angles according to claim 12, wherein a second installation groove is provided on the installation base, and the worm shaft is provided in the second installation groove;
one side of the second installation groove is communicated to the second shaft hole, and the other side of the second installation groove is communicated to the third installation groove;
one side of the second installation groove away from the second shaft hole is open, and a positioning plate is provided in the second installation groove, the first shaft hole is provided on the positioning plate.

14. The bracket with adjustable angles according to claim 13, wherein the positioning plate has a positioning portion and two connection portions, the positioning portion is provided between the two connection portions,
the first shaft hole is provided on the positioning portion, the third installation groove has a first concave portion corresponding to the positioning portion and two second concave portions corresponding to the two connection portions one by one,
the positioning portion is partially embedded in the first concave portion, each of the two connection portions is provided with a first connection hole, each of the second concave portions is provided with a second connection hole, and the two connection portions are embedded in the corresponding second concave portions, the screw passing through the first connection hole and the second connection hole in sequence so as to connect the positioning plate and the installation base.

15. The bracket with adjustable angles according to claim 12, wherein end faces of the first installation shaft and/or the second installation shaft are provided with adjustment holes, and the installation base is provided with a through hole for exposing the adjustment holes.
